(19) United States
(12) Patent Application Publication
(10) Pub. No.: US 2012/0267477 A1
(43) Pub. Date: Oct. 25, 2012

(54) Valve stem access system for aircraft

(76) Inventor: John Frederick Ellenberg, DeLeon Springs, FL (US)

(21) Appl. No.: 13/200,939

(22) Filed: Oct. 5, 2011

Related U.S. Application Data
(60) Provisional application No. 61/457,572, filed on Apr. 22, 2011.

(51) Int. Cl. B64C 25/00; B32B 38/10

(52) U.S. Cl. 244/103 R; 156/153

(57) ABSTRACT

A valve stem access system including a valve stem access assembly for an aircraft wheel cover is provided. One variation of the valve stem access system is designed for installation on a surface of an aircraft wheel fairing or pant and includes an installation template and positioning and cutting guide for accurate location and attachment of a valve stem access assembly that provides easy access to the aircraft wheel tire valve stem through a movable access panel. An alignment and indicator guide provides visual confirmation that the valve stem is correctly aligned with the access assembly. In another variation, a valve stem access assembly for an aircraft wheel hub cover is also provided.

### PRIORITY INFORMATION

This application claims priority from U.S. Provisional Patent Application No. 61/457,572, filed Apr. 22, 2011.

### BACKGROUND OF THE INVENTION

A critical factor in aircraft preventive maintenance is ensuring that the aircraft tires are maintained at an optimum tire pressure. Aircraft operate under conditions that cause tires to lose pressure faster than the tires of other vehicles. High pressures, high loads, and the specific designs of aircraft tires and wheels may produce this more rapid pressure loss. Problems caused by incorrect aircraft tire pressure can be serious. Overinflated tires can suffer uneven tread wear, reduced braking traction, and increased susceptibility to cutting, in addition to causing greater stress on wheels and landing gear. Underinflated tires also can wear unevenly and will experience increased stress and flex heating, which shortens tire life and can lead to tire failure. As a result, pilots or maintenance personnel ideally should check aircraft tire pressure at least daily, preferably before the first flight, when the tires are at ambient temperatures for the most accurate readings. Tire temperatures can increase 30° to 50° F. during aircraft operation, and every increase of 5° F. results in approximately a 1% pressure change. It is generally recommended that aircraft tire pressure checks be performed at sufficiently frequent intervals to ensure that, optimally, the tire pressure is held within the limits of about 5% per day to identify and rapidly fix potential sources of tire pressure loss to avoid tire failure and other problems.

Aircraft operators, pilots, and maintenance personnel appreciate the need to check aircraft tire pressure frequently. The typical construction of aircraft wheels, wheel fairings, hub caps, tires, and accessory structures, however, makes this routine task challenging and time consuming. The position of the tire valve stem, in particular, is generally in a location that is very difficult to access. While this is a problem in almost all aircraft, in small aircraft checking the tire pressure can be especially daunting. The wheels of many models of small aircraft are covered by wheel fairings or pants to reduce drag produced by uncovered wheels and to improve aerodynamic properties during flight. Improving the aerodynamics of the wheels of small aircraft by covering them with wheel fairings or pants can increase flight speed by up to 10 miles per hour (mph).

Many wheel pants provide some sort of opening through which a tire valve stem could be reached. Other wheel pants or fairings, however, do not provide any type of service port. One currently used wheel pant has a circular opening that measures about 2 inches in diameter for accessing the tire valve stem. Although this opening remains in the same location, the valve stem rotates with the aircraft tire and most likely is not aligned with the opening when it is time to check the aircraft tire pressure. In a small aircraft, rotating a tire to align the valve stem with an opening of this size in the pant is not only time-consuming, but can be quite frustrating, especially when there is only one person available to try to maneuver the tire to align the valve stem with the pant opening. Because the pant almost completely covers the tire, the valve stem is not visible and must be located by inserting fingers into the pant opening and hoping to feel the valve stem near the opening. In small aircraft, the usual method of rotating the aircraft tire to try to align the valve stem with the pant opening is to pull the aircraft forward by the propeller a small distance, go to the wheel, and check whether the valve stem can be felt through the pant opening. If not, the process must be repeated until the valve stem can be detected through the pant opening. Once the valve stem is located, a valve stem extension may be needed to reach the valve stem and connect it with a pressure gauge. This process, which must be repeated to check the tire pressure for each of at least three wheels, can take well over an hour or more until the valve stem can be detected through the opening. While the presence of another person may speed up the process somewhat, checking aircraft tire pressure still requires a significant amount of time and should be performed each day before the aircraft can take off on a flight. If there is no opening, the fairing must be completely removed, which is an also a frustrating, time consuming process.

On aircraft wheels not covered by aerodynamic wheel fairings or pants, such as those used in retractable landing gear, the wheel hubcap typically covers the tire valve stem completely. Removal of the hubcap is required to access the valve stem and check tire pressure. In many aircraft, the hubcap or hub cover, which is usually made of metal, is held in place on the wheel rim by a number of screws. While removal of the hubcap to access the tire valve stem is not as time-consuming a process as aligning the tire valve stem with a wheel pant opening, this arrangement presents its own challenges. Currently available wheel hub cover designs require the removal of all of the screws holding the hub cover on the wheel rim to access the valve stem. Both the screws and the wheel rim are easily damaged during this process. While damaged screws might be able to be replaced, if the costly wheel rim is also damaged, which is highly likely, replacement is required.

Structures that provide access to aircraft tire valve stems are known. One such structure is a hinged panel for a wheel fairing or pant. Another available structure is a separate hubcap intended to cover the entire wheel rim. A removable access panel in the hubcap is positioned over the valve stem. While structures such as those described may provide valve stem access, they are not without drawbacks. The hinged pant panel, although larger than typical pant openings, still requires the painstaking process of alignment of the valve stem with the panel before tire pressure can be checked. The hinge and closure arrangement also appears to add unnecessary weight and drag to the wheel fairing. The hubcap with a valve stem access panel uses a Camlock® type fastener to hold the access panel in place, also adding extra weight to this structure. An additional challenge posed by these structures is the interference with ventilation as a result of completely covering the original pant opening or wheel hub. Neither of the foregoing structures includes structure that effectively dissipates heat generated by the aircraft wheel, brakes, or other components.

The prior art, therefore, fails to disclose a tire valve stem access system that can be employed to accurately position and install a tire valve access structure on an aircraft wheel fairing or pant to facilitate alignment of the tire valve stem with the access structure to simplify the checking of tire pressure. The prior art further fails to disclose a method that enables a single person to use a tire valve access system to simply and correctly align the valve stem with an access panel in a valve stem access system to allow tire pressure to be checked. The prior art additionally fails to disclose a hubcap structure for an aircraft wheel with a lightweight tire valve stem access assembly that is securely and integrally supported by the hubcap.

### SUMMARY OF THE INVENTION

It is a primary object of the present invention, therefore, to provide a tire valve stem access system that accurately positions and permits accurate installation of a tire valve access assembly on an aircraft wheel fairing or pant to facilitate the accurate alignment of the valve access assembly with an aircraft wheel tire valve stem to allow tire pressure to be checked easily.

It is another object of the present invention to provide a lightweight valve stem access assembly in an aircraft wheel hubcap securely and integrally supported by the hubcap.

It is a further object to provide a simplified method for accurately installing a valve stem access assembly in an aircraft wheel fairing or pant and accurately aligning the aircraft wheel tire valve stem with the access assembly, whereby the tire valve can be quickly and easily accessed to check tire pressure.

It is an additional object of the present invention to provide a removable valve stem access assembly designed to be installed in an aircraft wheel hub cover with a stepped cross sectional configuration.

It is yet another object of the present invention to provide valve stem access assembly for an aircraft wheel fairing with an aerodynamic configuration.

It is yet a further object of the present invention to provide a valve stem access assembly for an aircraft wheel fairing configured to ventilate the wheel structures covered by the fairing and dissipate heat generated by operation of the aircraft wheel components.

It is a still further object of the present invention to provide an installation template for ensuring the precise and efficient installation of an aircraft wheel tire valve stem access assembly.

The foregoing objects are accomplished by providing a valve stem access assembly, positioning structure for the optimum installation of the access assembly on an aircraft wheel fairing or pant, and alignment indicia to facilitate the accurate alignment of the valve stem with the access assembly to permit easy access to the valve stem so tire pressure can be properly monitored. In another variation, valve stem access structure is provided integrally with a wheel hub cover for a wheel that is not covered by a fairing. The valve stem access assemblies of both variations are configured to be removably supported on a frame in an arrangement that conforms to the shape of the structure on which they are mounted in a way that minimizes weight of the overall access structure. The wheel pant access structure includes aerodynamically configured ventilation structures designed to dissipate heat generated by operation of the aircraft wheel, brakes, and the like.

Other objects and advantages will be apparent from the following drawings, description, and claims.

### BRIEF DESCRIPTION OF THE DRAWINGS

FIG. 1 illustrates an aircraft with wheels covered by aerodynamic fairings or pants;

FIG. 2 illustrates a wheel fairing removed from an aircraft wheel with one type of valve stem access assembly according to the present invention installed in a preferred location on the wheel fairing;

FIG. 3a is a top view of a support frame element of the access assembly shown in FIG. 2;

FIG. 3b is a cross section of the support frame element of FIG. 3a taken along lines A-A of FIG. 3a;

FIG. 4a shows an access panel element mounted in the support frame element of the access assembly shown in FIG. 2;

FIG. 4b is a cross section of the access assembly of FIG. 4a taken along lines B-B of FIG. 4a;

FIG. 5 shows the access assembly of the present invention in a perspective plan view as it appears from the interior of the wheel fairing or pant;

FIG. 6 illustrates a preferred installation template or stencil for the access assembly shown in FIG. 2;

FIG. 7a is a top view of one type of valve stem access assembly according to the present invention suitable for installation in an aircraft wheel hub cover;

FIG. 7b is a cross section of the valve stem access assembly of FIG. 7a taken along lines C-C;

FIG. 8a is a top view of a second type of valve stem access assembly according to the present invention suitable for installation in an aircraft wheel hub cover; and

FIG. 8b is a cross section of the valve stem access assembly of FIG. 8a taken along lines D-D.

### DESCRIPTION OF THE INVENTION

The access assembly and system of the present invention are designed primarily for installation on existing aircraft to facilitate access to tire valve stems and monitoring tire pressure. The ease with which tire pressure can be monitored by using the present valve stem access assembly and system simplifies the monitoring of aircraft tire pressure at optimum intervals so that the tire pressure can be kept within an acceptable range, thereby avoiding the problems that can accompany over- or under-inflated tires.

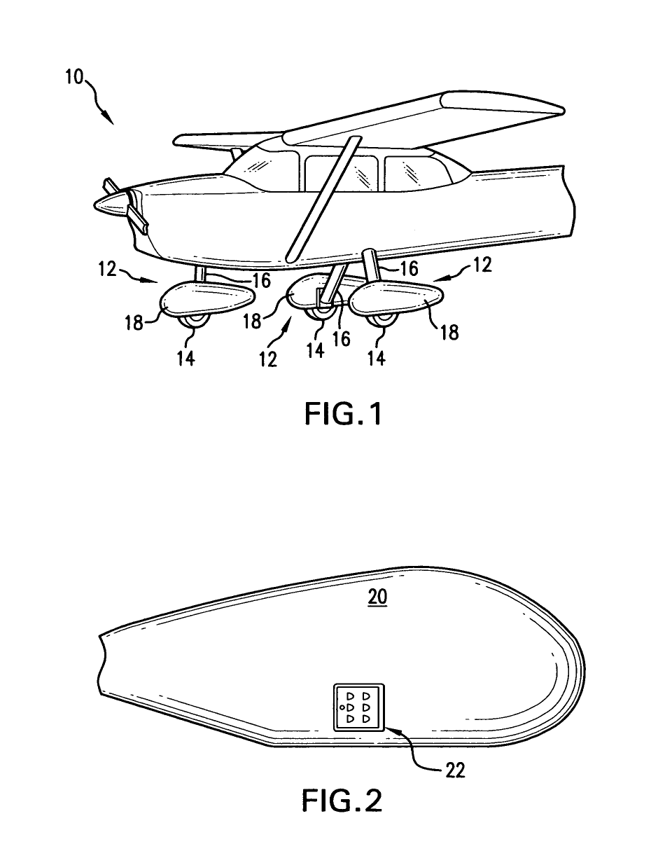

Referring to the drawings, FIG. 1 illustrates a small aircraft 10 that is equipped with three wheel assemblies 12. Each wheel assembly includes a tire 14 mounted on a wheel (not shown), a wheel strut 16, and a wheel fairing or pant 18. As discussed above, a wheel pant, such as pant 18, typically has an aerodynamic shape to minimize the drag created by wheels when the aircraft is in flight. This aerodynamically shaped pant almost completely covers the wheel and makes access to the tire valve stem (not shown) very difficult. The access system of the present invention provides accurate alignment and ready access to the valve stem.

FIG. 2 shows an aircraft wheel fairing or pant 20 that has been removed from an aircraft wheel with a valve stem access assembly 22 of the present invention installed in the aerodynamically configured exterior wall of the fairing. This portion of the fairing will cover the outer wall of a tire, such as the tire 14 shown in FIG. 1. The location of the valve stem access assembly 22 on the pant 20 is selected to provide optimum access to the tire valve stem without compromising the stability of the pant structure. Since most aircraft pants are slightly curved, the material used to form the elements of the access assembly 22 ideally is sufficiently flexible to conform to the curvature of the pant and strong enough to hold the elements of the assembly together during operation of the aircraft. One preferred material is 3003 aluminum, although other suitable materials for the valve stem access assembly elements that perform the functions described herein are also contemplated to be within the scope of the present invention. The valve stem access assembly 22 is shown in a preferred location on the surface of the fairing that is located outwardly of the center of the aircraft. The valve stem access assembly 22 could also be located in another part of the fairing, if desired, provided that the curvature of the fairing allows the assembly to be completely bonded to the fairing surface.

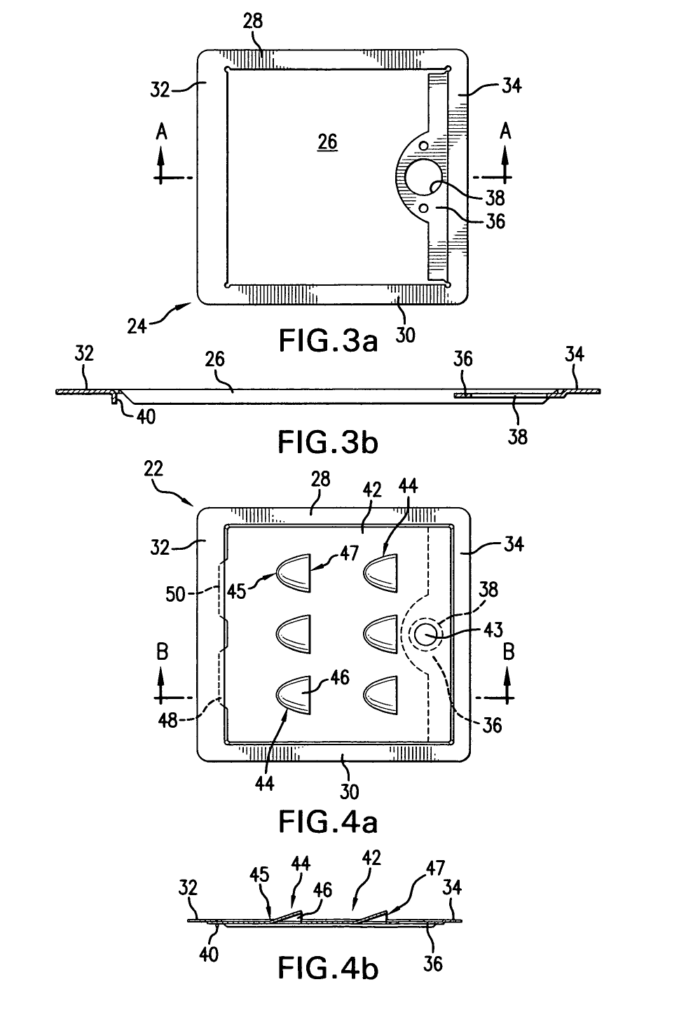

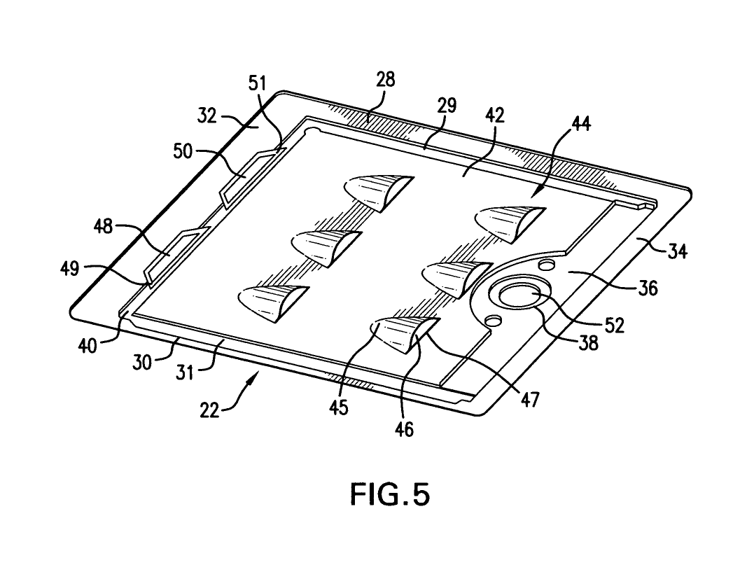

FIGS. 3a and 3b illustrate, respectively, top and cross sectional views of the valve stem access assembly support frame element 24. The support frame element 24 is attached to an exterior wall of a wheel pant 20, as shown in FIG. 2, to provide access to the valve stem, which is usually located in an outer wall of the wheel tire (not shown). The support frame element 24 has a substantially square configuration and surrounds an opening 26 in the wheel pant that is cut as described below. Other valve stem access assembly 22 configurations, including but not limited to rectangular, circular, or other suitable shapes, could also be used and are contemplated to be within the scope of the present invention. One set of opposed sides 28 and 30 of the support frame 24 are substantially identical. The other set of opposed sides 32 and 34 are not identical. Side 32 provides a continuous connection between sides 28 and 30. Side 34 includes a tab extension 36 that extends into the opening 26. The tab extension 36 includes a central opening 38 designed to receive a fastener, as will be discussed below in connection with valve stem access assembly panel element 42. It can be seen in FIG. 3b that the tab extension 36 is positioned to extend into the opening 26 slightly below the plane of the support frame element side 34. Support frame element side 32 is formed with a linear projection 40 that extends into the opening 26 and is parallel to side 32. Both the tab 36 and the linear projection 40 help to hold a planar access panel element 42 in place as shown in FIGS. 4a, 4b, and 5.

FIGS. 4a and 4b illustrate the valve stem access assembly panel element 42 in top view and in cross section. The panel element has a substantially rectangular configuration sized to fit within and be supported by the support frame element 24. An opening 43, positioned toward one edge of the panel element as shown in FIG. 4a, is located to be substantially axially aligned with the opening 38 on the frame support element extension tab 36. The planar face of the panel element 42 additionally includes a number of substantially three-dimensional triangle-shaped structures 44 that extend above the surface of the panel element, preferably arranged in parallel rows as shown in FIG. 4a. This arrangement gives the exterior surface of the panel element an appearance that is similar to that of a kitchen cheese grater. The triangle-shaped structures 44 also appear triangular as seen in side cross sectional view in FIG. 4b. Other shapes and arrangements could also be effectively used, however, provided that these shapes have an aerodynamic profile. The substantially triangular structures 44 shown in FIGS. 4a, 4b, and 5 can be formed in the panel element 42 by any of a number of known processes for forming such structures in flat sheets. The number and size of the triangular structures formed in the panel element 42 should not adversely affect the strength and integrity of the panel element.

The panel element 42 is positioned on the support frame element 26 so that the apex 45 of each substantially triangle-shaped structure is oriented toward the forward end of the aircraft, and the base 47 of each is oriented toward the rear of the aircraft. This orientation will reduce drag and increase the aerodynamic properties of this arrangement. Each triangle-shaped structure 44 covers a correspondingly shaped aperture 46 that extends from the base 47 of the triangle toward the apex 45. The apertures 46 permit air flow through the panel element 42 and provide ventilation for the wheel, brakes, and other adjacent wheel components to help dissipate heat generated during operation of these components. The location of the panel element 42 relative to the frame support element sides 28, 30, 32, and 34 and the extension tab 36 is shown in FIGS. 4a and 4b.

FIG. 5 illustrates the valve stem access assembly 22 of the present invention as it appears from the interior of the wheel fairing or pant 20. This view of the access assembly would not be visible from the exterior of the fairing after installation unless the fairing was removed from the wheel so that the interior wall of the fairing could be seen. It can be seen in this view that opposed frame element sides 28 and 30 have respective perpendicular extensions 29 and 31 that connect with linear projection 40 and form a lip around three sides of the frame element. The lip helps to hold the frame element in place in the wheel pant. The way in which the panel element 42 is structurally supported and held in place by the frame support element components can be clearly seen in FIG. 5. The panel element includes along the edge opposite the opening 43 a pair of spaced tabs 48 and 50 that are preferably configured to be secured in corresponding slots 49 and 51 in the frame support element, preferably in the linear projection 40 of frame support element side 32 as shown. The opposite edge of the panel element 42 with opening 43 is fully supported along its length by the frame support element extension tab 36 so that the extension tab opening 38 and the panel element opening 43 are axially aligned and a suitable fastener 52 can be inserted through both the panel element 42 and the frame support element extension tab 36 to lock these elements securely together.

A variety of suitable fasteners is available and could be used for this purpose. A preferred type of fastener must be approved for aircraft applications by the Federal Aviation Administration (FAA) and corresponding international regulatory authorities. The fastener must also be able to withstand the stresses encountered during repeated aircraft landings and take offs as well as frequent removal and replacement to access the tire valve stem to check tire pressure. One suitable type of fastener for this purpose is a one quarter (¼) turn fastener of the type sold under the CamLock® name, although a lighter weight fastener may be preferred in some applications. A zerk type fastener is another kind of fastener that is appropriate for this application. Other types of fasteners could also be employed.

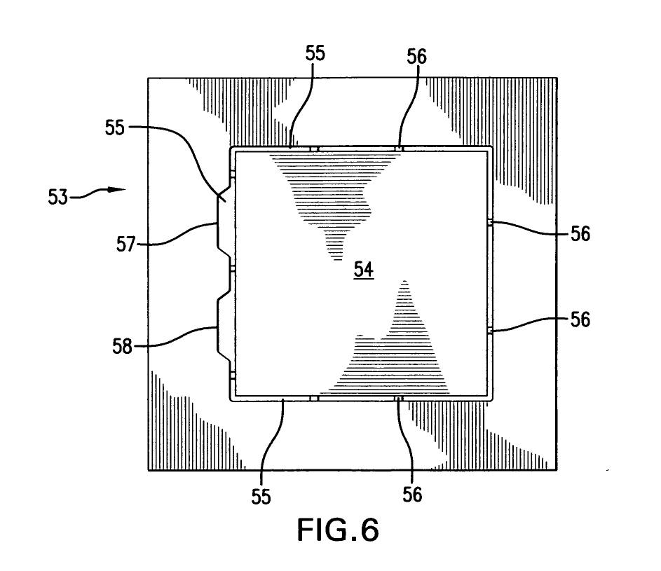

FIG. 6 shows a positioning and installation template or stencil 53 intended to be applied to the outer surface of the wheel pant. The proper use of the installation template or stencil 53 ensures a neat, precise placement of the valve stem access assembly and minimizes the likelihood of damage to the wheel fairing during installation. The installation stencil 53 should have the same configuration as the valve stem access assembly, which is preferably the substantially square shape described above and shown in FIGS. 2-5. Other convenient shapes may also be used and are contemplated to be within the scope of the present invention.

The template 53 is preferably in the form of a stencil that includes a central solid area 54 bordered by a peripheral open area 55, which becomes an aperture marking and cutting guide, as described below. The open area 55 should be wide enough to be colored in by a marking pen to form a line that will serve as a cutting guide. The central solid area 54 is lightly secured to the template 53 by connectors 56 spaced around the peripheral open area. The connectors 56 hold the central solid area in place and maintain the open area 55 so that the aperture cutting line can be marked and should be small enough not to interfere with marking the cutting line more than necessary. The open area 55 is shaped to correspond to the outline of the access panel element 42 and includes notches 57 and 58 corresponding to tabs 48 and 50.

The stencil 53 with the aperture marking and cutting guide formed by the open area 55 is used to ensure that the opening to be cut in the wheel fairing is centered and is the proper size and shape for receiving the frame support element 24. The dimensions of the marking and cutting guide should produce an opening that is slightly smaller than the dimensions of the frame support element 24 to ensure that the frame support element fits snugly within the opening cut according to the guide. The opening is cut to have the shape of the open area 55 shown in FIG. 6, which corresponds to the shape of the panel element 42.

The template or stencil 53 is preferably formed of a flexible plastic or similar material that can be held in place as described below while the aperture to be cut is marked as accurately as possible using the open area 55 as a guide.

To install the valve stem access assembly using the template or stencil 53, the surface of the fairing or pant is first cleaned. The stencil 53 is placed on the clean surface in the desired location. An easily removable adhesive-backed tape, such as, for example, that used by painters, is applied to the stencil 53 to hold it in place temporarily while the opening to be cut is marked. A permanent marking pen or other marker is used to fill in the open area 55 to define a cutting guide line for the aperture to be cut in the fairing. The stencil 53 is carefully removed. Using the cutting guide line marked, an opening is cut. Since wheel fairings or pants are typically fiberglass, a cutting tool appropriate for this material must be used to cut the opening.

The cut edges are preferably smoothed by sanding. When the opening 55 is ready, the frame 24 is fitted inside. To create a clear prep line, avoid damage to the fairing, and ensure easy clean up, a removable adhesive-backed tape, such as the painter's tape referred to above, may be applied to the fairing in a border around: the frame 24. The frame 24 is removed, and the fairing surface, typically fiberglass, is sanded or abraded in the area between the tape border and the opening. A suitable adhesive, preferably an epoxy type adhesive as described below, is applied to the area of the sanded fiberglass surface between the tape border and the opening. Adhesive is spread to cover the areas on the fairing that will be contacted by the frame support element 24. It is preferred that additional epoxy or other adhesive be applied to the reverse side of the support frame element along the lip (FIG. 5) on the underside of the pant to fully secure the valve stem access assembly to the wheel pant.

The valve stem access assembly frame support element 24 is then inserted into the opening. The support frame element 24 will be positioned so that the lip formed by structures 29, 31, and 40 is engaged by the edges of the opening, and the frame can be secured to the fairing. The slightly smaller dimensions of the opening ensure a tight fit of the support frame element within the opening. The frame support element 24 is optimally positioned with the tab extension 36 and aperture 38 toward the rear of the aircraft. When the panel element 42 is attached to the frame support element, the apices 46 of the triangular-shaped structures are directed toward the forward end of the aircraft to minimize drag during flight as discussed above.

The frame support element is preferably attached to a fiberglass surface with an epoxy type of adhesive suitable for forming a strong bond between the material of the frame support element, preferably a metal such as aluminum, and the fiberglass or other material of the wheel pant. One type of epoxy adhesive suitable for this purpose has a setting time of about 7 to 15 minutes, although other types of adhesives could also be used for this purpose. One adhesive preferred for this purpose is sold under the name LOCTITE® PoxyPak. If the epoxy adhesive is inadvertently applied outside the exposed fiberglass frame support area, the border of removable tape applied around the frame 24 will protect the surface of the wheel pant. After the adhesive has been applied to the exposed surface of the wheel pant and the frame support element is adhesively attached to the wheel pant surface, the adhesive border can be simply peeled off to leave a neat installation and a wheel pant surface free of excess epoxy.

Once the frame support element 24 has been firmly attached to the exterior surface of the wheel pant, the panel element 42 can be inserted into the support frame element as shown in FIG. 5, with tabs 48 and 50 inserted into slots 49 and 51 in the linear projection 40. The aperture 43 in the panel element will then align with the aperture 38 in the tab extension 36 so that a suitable fastener 52 can be inserted to lock the panel element and support frame element together as described above and shown in FIG. 2.

The valve stem access system of the present invention additionally includes indicia (not shown) to ensure accurate alignment of the valve stem and the access assembly panel element 42 so that one person can simply and easily align these structures without assistance. The initial alignment is accomplished more easily with at least two people, however. Once the aircraft has been moved, typically by pulling the propeller, so that the tire has rotated and the valve stem is clearly visible through the panel element 42 of the valve stem access assembly 22 and in the best possible position for attaching a pressure gauge to the valve stem, an indicator marking is applied to the inside surface of the tire, preferably in the form of a line extending perpendicularly from the ground contacting surface of the tire to the wheel hub. This indicator marking must be clearly visible on the tire below the wheel fairing and easily seen from the location of the aircraft propeller. The alignment of the tire indicator marking so that it is perpendicular to the ground indicates that the valve stem is accurately positioned for access through the access assembly panel element 42. It is preferred that the tire indicator marking be formed of a substantially permanent material that adheres securely to the outer surface of the tire and is clearly visible from at least the distance between the tire and the propeller. This material must also be able to be re-applied over the initial indicator marking, if needed. One material found to be suitable for this purpose is a fluorescent type of paint formulated for rubber available with a single use applicator available from Ace Hardware stores, although other suitable materials are also contemplated to fall within the scope of the present invention. While yellow may be a preferred color because of its visibility, other distinctively visible colors could also be used for this purpose.

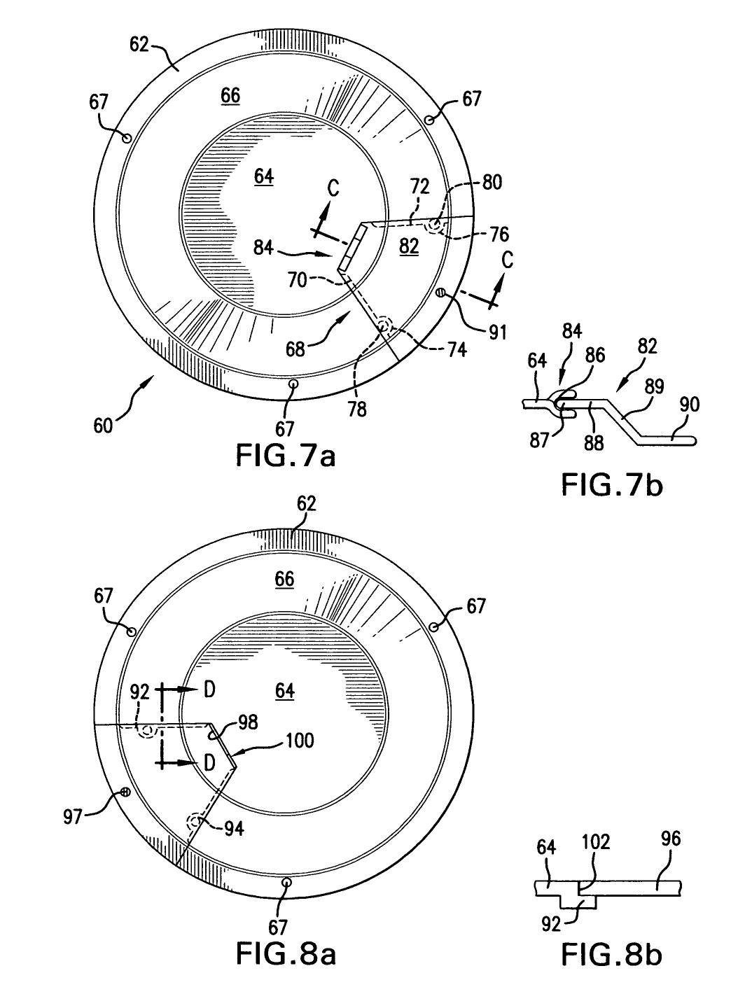

FIGS. 7a and 7b and 8a and 8b illustrate a variation of the valve stem access system of the present invention suitable for installation in a wheel hub cover or hubcap. In this variation, the configuration of the access assembly must conform to the configuration of the wheel hub cover, which typically includes a circumferential planar ring with the same diameter as the wheel rim and a smaller diameter central planar surface spaced a sufficient distance from the planar ring to cover the wheel hub. A circumferential angled wall connects these planar surfaces so that wheel hub cover has a stepped appearance similar to that of an upside down pie plate, as shown in cross section in FIG. 7a. A valve stem access assembly for this application requires a different configuration than the essentially planar or slightly curved wheel fairing design described above. A hubcap with an access assembly as described in connection with FIGS. 7a, 7b, 8a, and 8b can be made at a location remote from the aircraft and then simply installed in place of an existing aircraft hubcap that has no access assembly. The access assemblies shown in FIGS. 7a and 8a have a substantially similar configuration; each includes different structures for attaching the access panel element of the assembly to the hubcap.

FIGS. 7a and 7b illustrate a wheel hub cover or hubcap 60 with a circumferential planar ring section 62, a central planar section 64 spaced inwardly and away from planar section 62, and an angled section 66 connecting the two planar sections. The wheel hub cover may be attached to the wheel rim by several suitable fasteners 67 spaced at selected intervals. A valve stem access assembly 68, preferably with a truncated triangle shape as shown in FIGS. 7a and 8a, extends from the circumferential planar ring section 62 toward the central planar section 64. The truncated triangle shape facilitates the attachment of the access assembly to the substantially circular hubcap. This valve stem access assembly includes support frame structure that is functionally the same as the support frame element in FIGS. 2-5, but is formed integrally with the hubcap. An opening with the truncated triangle shape shown is cut in the hubcap so that a pair of bearing ledges 70 and 72 is formed along opposed edges of the opening between the central planar section 64 and the circumferential ring section 62. The bearing ledges 70 and 72 are formed with integral tab projections 74 and 76 that include apertures 78 and 80, respectively, to support an access panel 82. The location of the tab projections 74 and 76 can be varied along the length of the bearing ledges as required to maximize the strength of the support provided to the access panel and access to the valve stem (not shown). An arrangement of alternating up and down bends could also be used in place of the bearing ledges 70 and 72 to support the access panel 82. Along the truncated triangular portion 84 of the hubcap, a series of alternating up and down bends are formed in the hubcap to form a groove 86 configured to receive an end 87 of a planar surface 88 in the access panel 82 that corresponds to the hubcap planar surface 64. This configuration is shown in FIG. 7b, which is a cross section taken along lines C-C of FIG. 7a. The access panel 82 has a cross sectional configuration corresponding to the cross sectional configuration of the hubcap 60, with an angled section 89 connecting a planar section 88 to a planar wheel rim-contacting section 90. If needed, a gasket (not shown) could be inserted in the groove 86 and/or along the bearing ledges 70 and 72 to further secure the access panel 82 and/or seal the interior of the wheel hub.

To secure the access panel 82 in place on the bearing ledges 70 and 72, apertures are provided in the access panel 82 to correspond with the apertures 78 and 80 in the bearing ledges supporting the access panel 82. Preferred fasteners for holding the access panel in place on the bearing ledges are lightweight fasteners. For example, replaceable inserts made of nylon, plastic, rubber, or like materials placed in the bearing ledge apertures that accept a wafer head screw sized to prevent pullout or shear are contemplated for this purpose. Alternatively, an insert made of a similar material could be placed within each bearing ledge aperture to hold a screw inserted through the access panel aperture. Inserts and screws of this type are readily available and can be easily replaced when worn. An additional fastener 91, preferably of the plastic insert and screw type, further secures the access panel planar section 90 to the circumferential planar ring section 62 of the wheel hub cover 60.

FIGS. 8a and 8b further illustrate a wheel hub cover or hubcap substantially similar to that shown in FIG. 7a, but with a different type of access panel 96. The support structures formed integrally with the hubcap are substantially the same in FIG. 8a as in FIG. 7a, and bearing ledges 92 and 94 support opposed edges of an access panel 96. The attachment of the access panel 96 to the truncated end 98 of the hubcap opening differs from that shown in FIGS. 7a and 7b in that the access panel 96 includes a hinge element 100 that replaces the arrangement of alternating bends used to attach the access panel 82. While a rolled hinge is preferred, any suitable hinge may be employed for this purpose. The edge of the access panel 96 opposite the hinge 100 is secured in place on the hubcap by a fastener 97, which may be the same type of fastener as fastener 91 in FIG. 7a. FIG. 8b, which is a view along line D-D of FIG. 8a, shows in cross section the access panel 96 supported on bearing ledge 92. A gasket 102 can be inserted as needed to further secure the access panel and/or seal the wheel hub. The fasteners described in connection with FIGS. 7a and 7b could also be used with the access assembly shown in FIGS. 8a and 8b.

The wheel hub covers or hubcaps and access panels described in connection with FIGS. 7a, 7b, 8a, and 8b could be formed of a variety of different materials that are suitable for use in an aircraft wheel environment. Exemplary materials include steel, aluminum, plastics, and composites, although other suitable materials are contemplated to be within the scope of the present invention.

While the present invention has been described with respect to preferred embodiments, this is not intended to be limiting, and other arrangements and structures that perform the required functions are contemplated to be within the scope of the present invention.

### INDUSTRIAL APPLICABILITY

The access system of the present invention will find its primary applicability in connection with facilitating access to an aircraft tire valve stem to enable easy monitoring of tire pressure. While the primary use of the valve stem access assembly of the present invention is intended to be as an aftermarket installation, this access assembly could also be installed as original equipment by the wheel fairing, wheel hub cover, or aircraft manufacturer. This access system could also be effectively employed in a range of other applications where easy access to a structure that must be kept covered is desired.

1. A valve stem access system for installation on an external surface of an aircraft wheel fairing to provide access to a tire valve stem whereby tire pressure may be monitored, said fairing covering a wheel supporting a tire with a valve stem, wherein said valve stem access system comprises
(a) valve stem access assembly means selectively operable to provide open access to said tire valve stem or to cover said tire valve stem;
(b) valve stem access assembly positioning and installation template means for precisely locating the valve stem access assembly means in the fairing exterior wall and guiding the installation of said valve stem access assembly means so that the valve stem access assembly means is accurately and neatly installed in the fairing exterior surface to provide optimum access to said tire valve stem; and
(c) valve stem alignment and indicator means for providing a visual indicator readable at a distance of the location of the tire valve stem and the alignment of the valve stem with the access assembly means.

2. The valve stem access system described in claim 1, wherein said valve stem access assembly means includes support frame means secured to said fairing exterior surface for supporting the valve stem access assembly on the fairing and removable access panel means supported by said support frame means and operable to open or close the valve stem access assembly to expose or cover the tire valve stem.

3. The valve stem access system described in claim 2, wherein said support frame means includes apertured tab extension means for supporting at least a portion of said access panel means, said access panel means includes in said portion supported by said tab extension means an aperture positioned to align with an aperture on said tab extension means, and lockable fastener means are provided to extend through the aligned apertures to removably lock said access panel means to said extension tab means.

4. The valve stem access system described in claim 2, wherein said access panel means includes tab means configured to engage corresponding structure on said support frame means to removably support said access panel means on said support frame means.

5. The valve stem access system described in claim 1, wherein said valve stem access assembly means has a substantially square or rectangular configuration.

6. The valve stem access system described in claim 2, wherein said access panel means includes a plurality of aerodynamically configured vent means for ventilating said wheel and tire covered by the fairing and permitting heat generated by the wheel and tire to dissipate.

7. The valve stem access system described in claim 6, wherein each of said plurality of vent means has a substantially three dimensional triangular configuration and each of said plurality of vent means is positioned on said access panel with the apex of the triangle toward the forward end of the aircraft and the base toward the rear of the aircraft.

8. The valve stem access system described in claim 5, wherein said support frame means includes an exterior substantially rectangular perimeter spaced outwardly from a substantially rectangular interior perimeter with a planar surface therebetween forming a frame and at least a portion of said interior perimeter is formed with a lip extending away from said planar surface to contact an opening in the wheel fairing when the support frame means is installed in the wheel fairing surface.

9. The valve stem access system described in claim 1, wherein said valve stem access assembly positioning and installation template means is a flexible structure configured to provide cutting guide means to correspond to the shape of an opening required to be cut in the wheel fairing to receive said valve stem access assembly.

10. The valve stem access system described in claim 9, wherein said cutting guide means comprises a stencil on said template means.

11. The valve stem access system described in claim 1, wherein said valve stem alignment and indicator means includes distinctly visible indicia applied to said tire at a location easily read to indicate that the valve stem is aligned with and accessible through said valve stem access assembly means.

12. A method for installing a valve stem access system on a surface of an aircraft wheel fairing covering a tire mounted on an aircraft wheel, including the steps of
(a) providing a template or stencil with a valve stem access system aperture marking and cutting guide;
(b) temporarily securing the template to the wheel fairing and using the aperture marking and cutting guide to mark an outline of an opening to be cut and removing the template;
(c) following the outline, cutting an opening in the fairing surface and sanding the edges of and an area around the opening;
(d) fitting a frame section of the valve stem access assembly into the opening, applying a border of removable adhesive-backed tape on the fairing around a periphery of the frame section, and removing the frame section;
(e) applying an adhesive selected to securely fasten the frame section to said fairing surface to an area on the fairing between the opening and the border of tape and fitting the frame section into the opening so that the frame section directly contacts the applied adhesive and removing the adhesive-backed tape; and
(f) attaching an access panel section of said valve stem access system to said frame section so that the access panel is movable to cover the opening and to provide access to the opening and providing a fastener designed to keep the access panel secured in a closed condition during operation of the aircraft.

13. The method described in claim 12, further including the steps of
(a) moving the wheel to rotate the tire so that the tire valve stem is aligned with and easily reached through the access panel; and
(b) when the valve stem is aligned with the access panel, applying an indicating mark visible from a predetermined distance to a portion of the tire not covered by the fairing and easily visible from said predetermined distance to indicate that when the tire is in the position indicated, the valve stem will be aligned with the access panel.

14. A valve stem access assembly for a substantially circular wheel hub cover that covers the hub area on an aircraft wheel extending from the center to the rim of the wheel, wherein said valve stem access assembly includes
(a) support frame means formed integrally with the hub cover to define an opening with the shape of a truncated triangle for aligning with and providing access to the valve stem, with the base of said triangle located adjacent to the wheel rim;
(b) access panel means having a cross sectional configuration corresponding to that of the hub cover and configured to fit within and securely cover said opening;
(c) connector means to movably attach a truncated triangular portion of the access panel means to the support frame means and to the hub cover so that the access panel means is movable between a position completely covering said opening and a position providing access to the valve stem through said opening; and
(d) removable lightweight fastening means for securing the access panel means to the support frame means and to the wheel rim when said access panel means is required to remain in a closed position.

15. The valve stem access assembly described in claim 14, wherein said hub cover has a stepped cross sectional configuration and said connector means comprises a plurality of alternating up and down bends to form a groove for receiving an end of the access panel means to connect said access panel means to said hub cover.

16. The valve stem access assembly described in claim 14, wherein said hub cover has a stepped cross sectional configuration and said connector means comprises hinge means for hingedly connecting an end of said access panel means to said hub cover.
